(19) United States
(12) Patent Application Publication
(10) Pub. No.: US 2005/0133976 A1
(43) Pub. Date: Jun. 23, 2005

(54) Pneumatic spring

(76) Inventors: Andreas Kind, Hildesheim (DE); Stefan Narberhaus, Garbsen (DE); Joachim Jeischik, Wenningen (DE)

Correspondence Address: MCGUIREWOODS, LLP, 1750 TYSONS BLVD, SUITE 1800, MCLEAN, VA, 22102, US

(21) Appl. No.: 10/946,281

(22) Filed: Sep. 22, 2004

(30) Foreign Application Priority Data
Dec. 22, 2003 (DE) 103 61 089.8

(51) Int. Cl. F16F 5/00

(52) U.S. Cl. 267/64.11

(57) ABSTRACT

A pneumatic spring, in particular for vehicles, with a spring bellows which is secured to a clamping bottom via a clamping ring. Increased leak-tightness under pressure is provided by a sealing element being arranged between the pneumatic spring bellows and the clamping bottom.

### BACKGROUND OF THE INVENTION

1. Field of the Invention

The invention relates to a pneumatic spring, in particular for vehicles, with a pneumatic spring bellows which is secured to a clamping bottom via a clamping ring.

2. Background Description

A bellows fastening for pneumatic springs or the like, with a closed channel-shaped clamping ring, is known from DE 21 30 215 A1. A container tube has in this case a rectangular bead over which the pneumatic spring bellows to be fastened is drawn. The pneumatic spring bellows is held in the region of the bead against the container tube via a clamping ring, a supporting ring introduced between the bellows end and the upper bead edge ensuring that the clamping ring, together with the lower bead edge, forms, for the bellows, a clamping point, the pressure force of which increases with an increasing load in the direction of stress.

DE 44 01 770 A1 discloses a self pumping spring strut with leveling, in which a flexible outer wall is fastened to a rigid outer wall via a clamping ring.

DE 84 13 300 U1 discloses a pneumatic spring/damper unit, in which a bellows is fastened to a rolling sleeve via a clamping ring.

Fastening a pneumatic spring bellows to a clamping bottom presents the problems, on the one hand, of stable fastening and, on the other hand, of ensuring leaktightness under pressure in the clamping region, particularly in the event of temperature fluctuations.

### SUMMARY OF THE INVENTION

The invention provides a pneumatic spring which, along with stable clamping, provides sufficient leaktightness in the clamping region.

According to the invention, provided is a pneumatic spring with a pneumatic spring bellows which is secured to a clamping bottom via a clamping ring, and an additional sealing element arranged between the pneumatic spring bellows and the clamping bottom. Particularly in the event of pronounced temperature fluctuations, the leaktightness of the pneumatic spring under pressure is ensured, in that the additional, if appropriate separate, sealing element affords an additional sealing-off effect. Owing to the elastic deformation of the sealing element even in the event of pronounced temperature fluctuations and of the associated deformations of the clamping bottom, the leaktightness of the pneumatic spring under pressure remains ensured under all operating conditions.

A development of the invention provides for a reception device for the sealing element to be arranged in the clamping bottom, in order to ensure an exact positioning of the sealing element. This reception device is designed, for example, as a groove or notch or as a stop or a step, into or onto which the sealing element is clamped or adhesively bonded or is braced in the groove or notch. Alternatively to being worked out as a groove, the reception device may also be designed, for example, in the form of bosses, which are formed on the clamping bottom and by means of which the sealing element, which may be designed, for example, as an O-ring or as another standard sealing element, is held at the intended location. The reception device is therefore a positioning device for the sealing element. In addition to the design as an O-ring, sealing elements with other cross-sectional shapes, for example rectangular or oval, may also be used. Materials used for the sealing element may be all sufficiently elastic materials, for example rubber, polyurethane or other elastomers.

In order to ensure that the clamping ring remains securely positioned, the clamping bottom is advantageously designed as a groove, so that an axial movement of the clamping ring is avoided by virtue of the groove walls of the clamping bottom which bear against the clamping ring.

The invention can be employed advantageously particularly with regard to thin pneumatic spring bellows, since, because of the small material thickness, only a small amount of flexibility is provided by the pneumatic spring bellows at the clamping point. In the event of temperature fluctuations or other loads, the invention is capable of compensating displacements or deformations at the clamping point and ensures the leaktightness of the pneumatic spring. Particularly with regard to pneumatic springs in passenger cars with external guidance, the pneumatic spring bellows have an especially thin design, thus entailing the problems described above. Particularly in the case of thin-walled pneumatic spring bellows, the additional sealing element ensures a good leaktightness of the clamping connection.

When the reception device or positioning device is designed as a groove, the sealing element is advantageously designed in such a way that the latter projects radially outward sufficiently to ensure the sealing function. This may be carried out in that the depth of the groove amounts to no more than ⅔ of the radial cross section of the sealing element, that is to say the sealing element projects radially outward with ⅓ of its diameter. In the individual instance, a projection of ¼ of the diameter may suffice, and likewise, in the event of pronounced dimensional fluctuations or high pressures, the projection may amount to ½ or ⅔ of the diameter.

### BRIEF DESCRIPTION OF THE DRAWINGS

An exemplary embodiment of the invention is explained below with reference to the figures in which:

FIG. 1 illustrates a sectional part view of a pneumatic spring; and

FIG. 2 illustrates a view of a detail of the pneumatic spring.

### DETAILED DESCRIPTION OF EMBODIMENTS OF THE INVENTION

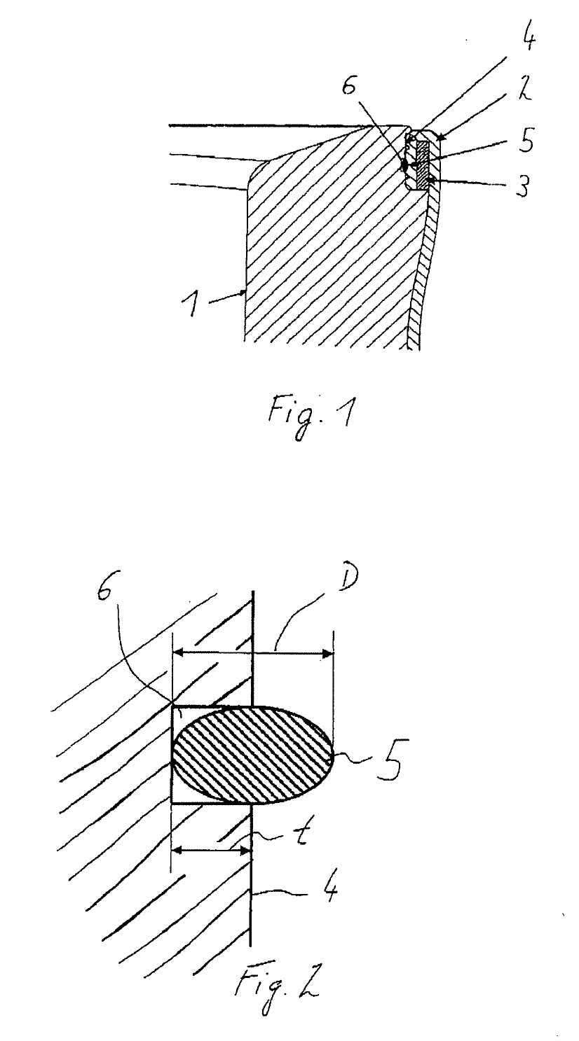

FIG. 1 illustrates a pneumatic spring piston 1, to which a pneumatic spring bellows 2 is fastened via a preferably peripheral clamping ring 3. The pneumatic spring bellows 2 in this case bears against a clamping bottom 4 of groove-shaped design and is secured to the pneumatic spring piston 1 via the clamping ring 3. The clamping ring 3 is in this case seated on a side wall of the clamping bottom 4 and is surrounded by the pneumatic spring bellows 2 on three sides, in that the pneumatic spring bellows 2 is folded round the clamping ring 3. The pneumatic spring bellows 2 bears against the pneumatic spring piston 1 and can roll on the latter.

An axial movement of the clamping ring 3 is prevented by virtue of the groove-shaped design of the clamping bottom 4, the groove walls being dimensioned differently. In the clamping bottom 4 itself, an at least partially peripheral groove 6 is formed, into which a sealing element 5 is introduced in order to ensure that the pneumatic spring is sealed off. Particularly in the event of temperature fluctuations, the additionally present sealing element 5 ensures an improvement in leaktightness under pressure in the clamping region. The elastic sealing element 5 is in this case designed in such a way that, even in the event of pronounced temperature fluctuations and of associated deformations of the clamping bottom 4, the elasticity is sufficient to ensure the leaktightness of the pneumatic spring under pressure.

The design of the reception device 6 as a groove ensures the exact positioning of the sealing element 5. Alternatively to a groove being cut out by milling, positioning aids in the form of bosses or of segmentally arranged elevations may be present on the clamping bottom 4, in order to ensure that the sealing element is assigned exactly to the pneumatic spring bellows 2 and to the clamping ring 3.

What is achieved by the arrangement of an additional sealing element 5, in addition to the improvement in leaktightness, is that the requirements as regards the machining of the clamping bottom 4 can be reduced. In terms of the surface quality, roundness and geometry of the clamping bottom 4, lower requirements can be set because of the additional sealing element, thus affording a cost benefit. Since, on account of the presence of the additional sealing element 5, the surface of the clamping bottom 4 needs to have a lower surface quality in order to ensure the same leaktightness, with the clamping force of the clamping ring 3 being the same, a higher strength of the pneumatic spring bellows 2 is ensured due to the higher surface roughness. The clamping region or clamping bottom 4 would otherwise have had to be additionally roughened by means of complicated knurling methods.

Alternatively to the fastening of the pneumatic spring bellows 2 to a pneumatic spring piston 1, there may also be provision for fastening to a pneumatic spring cover or, correspondingly, to other components of a pneumatic spring.

With a suitable choice of material, the sealing element 5 may be vulcanized into the pneumatic spring bellows 2 or adhesively bonded to it, but, alternatively, integration into the clamping bottom 4 or into the reception device 6 may take place by adhesive bonding, clamping, bracing or injection.

FIG. 2 shows a view of a detail of the clamping bottom 4 with the reception device 6 designed as a groove. The spring bellows 2 is not yet mounted, so that the sealing element 5, which is clamped into the groove 6, projects beyond the clamping bottom 4. The groove depth t is in this case less than the diameter D of the sealing element 5 or than the radial extent of the sealing element 5, so that, even in the event of relatively pronounced dimensional fluctuations or displacements of, for example, the pneumatic spring piston 1, the sealing action is maintained.

In the illustration according to FIG. 2 of the drawing, the difference between the radial extent D of the sealing element 5 and the groove depth t amounts to approximately half the radial extent D, but alternative dimensions are possible and depend on the technical requirements. The sealing element 5 according to FIG. 2 is designed as an elastomeric ring with an oval cross section, but other cross-sectional shapes or designs of the sealing elements are likewise provided.

While the invention has been described in terms of preferred embodiments, those skilled in the art will recognize that the invention can be practiced with modification within the spirit and scope of the appended claims.

1. A pneumatic spring, comprising a pneumatic spring bellows secured to a clamping bottom via a clamping ring, and an additional sealing element arranged between the pneumatic spring bellows and the clamping bottom.

2. The pneumatic spring as claimed in claim 1, further comprising a reception device for the sealing element arranged in the clamping bottom.

3. The pneumatic spring as claimed in claim 2, wherein the reception device includes a positioning device, including one of a groove, a notch, a stop and a step.

4. The pneumatic spring as claimed in claim 1, wherein the sealing element is an 0-ring.

5. The pneumatic spring as claimed claim 1, wherein the sealing element is produced from an elastic material, comprising one of elastomer, rubber and polyurethane.

6. The pneumatic spring as claimed in claim 1, wherein the sealing element is vulcanized into the pneumatic spring bellows or is adhesively bonded to the pneumatic spring bellows.

7. The pneumatic spring as claimed in claim 2, wherein the sealing element is secured to the clamping bottom by one of clamped, adhesively bonded and braced in the reception device.

8. The pneumatic spring as claimed in claim 1, wherein the clamping bottom is a groove.

9. The pneumatic spring as claimed in claim 1, wherein the clamping bottom is formed on a pneumatic spring piston or a pneumatic spring cover.

10. The pneumatic spring as claimed in claim 3, wherein the positioning device is a groove, the depth of which amounts to no more than ⅔ of a radial cross section of the sealing element.

11. A pneumatic spring, comprising:
a pneumatic spring bellows secured to a clamping bottom via a clamping ring;
a sealing element arranged between the pneumatic spring bellows and the clamping bottom; and
positioning means for positioning the sealing element between the spring bellows and the clamping bottom.

12. The pneumatic spring as claimed in claim 11, wherein the positioning means is one of groove, a notch, a stop and a step provided on the clamping bottom.

13. The pneumatic spring as claimed in claim 12, wherein the sealing element is clamped or adhesively bonded or braced in or on the positioning means.

14. The pneumatic spring as claimed in claim 11, wherein the positioning means are bosses, which are formed on the clamping bottom.

15. The pneumatic spring as claimed in claim 11, wherein the positioning means is a groove and a difference between a radial extent “D” of the sealing element and the groove depth “t” amounts to approximately half the radial extent “D”.

16. The pneumatic spring as claimed in claim 11, wherein the positioning means is a groove positioned in the clamping bottom and axial movement of the clamping ring is avoided by virtue of the groove walls.

17. The pneumatic spring as claimed in claim 11, wherein the positioning means is a groove and the sealing element projects radially outward to ensure sealing function.

18. The pneumatic spring as claimed in claim 17, wherein the depth of the groove amounts to no more than ⅔ of a radial cross section of the sealing element.

19. The pneumatic spring as claimed in claim 11, wherein the sealing element is produced from an elastic material.

20. The pneumatic spring as claimed in claim 11, wherein the sealing element is vulcanized into the pneumatic spring bellows or is adhesively bonded to the pneumatic spring bellows.
